(19) United States
(12) Patent Application Publication
(10) Pub. No.: US 2013/0258212 A1
(43) Pub. Date: Oct. 3, 2013

(54) TELEVISION RECEIVER AND ELECTRONIC APPARATUS

(71) Applicant: KABUSHIKI KAISHA TOSHIBA, Tokyo (JP)

(72) Inventors: Toshio OOE, Tokyo (JP); Minoru ENOMOTO, Tokyo (JP)

(73) Assignee: KABUSHIKI KAISHA TOSHIBA, Tokyo (JP)

(21) Appl. No.: 13/716,559

(22) Filed: Dec. 17, 2012

(30) Foreign Application Priority Data
Mar. 30, 2012 (JP) 2012-082526

(51) Int. Cl. H04N 5/64

(52) U.S. Cl. CPC H04N 5/64
USPC 348/836

(57) ABSTRACT

According to one embodiment, an electronic apparatus includes: a display comprising a screen; a housing configured to house at least a part of the display when the screen is exposed; three supports configured to protrude from the housing and to support the housing; a container configured to be provided on a side of the housing and located among the three supports, the side opposite the screen; and a housed part configured to be housed in a detachable manner in the container.

### CROSS-REFERENCE TO RELATED APPLICATIONS

This application is based upon and claims the benefit of priority from Japanese Patent Application No. 2012-082526, filed on Mar. 30, 2012; the entire contents of which are incorporated herein by reference.

### FIELD

An Embodiment described herein relates generally to a television receiver and an electronic apparatus.

### BACKGROUND

Television receivers provided with batteries have been known.

Such types of television receivers are requested that the batteries provided to housings thereof cause less inconvenience.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary front view illustrating a television receiver according to an embodiment;

FIG. 2 is an exemplary perspective front view illustrating the television receiver in the embodiment;

FIG. 3 is an exemplary rear view illustrating the television receiver in the embodiment;

FIG. 4 is an exemplary side view illustrating the television receiver in the embodiment when a support is unfolded;

FIG. 5 is an exemplary side view illustrating the television receiver in the embodiment when the support is folded;

FIG. 6 is an exemplary perspective view illustrating a part including a first support of the television receiver in the embodiment when viewed from a front side of the television receiver;

FIG. 7 is an exemplary perspective view illustrating apart including the first support of the television receiver in the embodiment when viewed from a rear side and a lower side of the television receiver;

FIG. 8 is an exemplary perspective view illustrating an internal structure of the first support of the television receiver in the embodiment;

FIG. 9 is an exemplary exploded perspective view illustrating a part including the first support of the television receiver in the embodiment when viewed from the rear side and the lower side of the television receiver;

FIG. 10 is an exemplary perspective view illustrating apart including a second support of the television receiver in the embodiment when viewed from the rear side and the lower side of the television receiver;

FIG. 11 is an exemplary front view illustrating a part of the television receiver in the embodiment;

FIG. 12 is an exemplary rear view illustrating an inside of a housing of the television receiver in the embodiment;

FIG. 13 is an exemplary rear view illustrating an inside of the housing of the television receiver in the embodiment when a cover is removed;

FIG. 14 is an exemplary rear view illustrating a part of the inside of the housing of the television receiver in the embodiment;

FIG. 15 is an exemplary view on arrow XV of FIG. 14;

FIG. 16 is an exemplary rear view illustrating a part of the housing of the television receiver in the embodiment;

FIG. 17 is an exemplary perspective view illustrating a cap of the television receiver in the embodiment when viewed from the front side;

FIG. 18 is an exemplary perspective view illustrating a portion to which a container is provided of the housing of the television receiver in the embodiment when a cap is removed;

FIG. 19 is an exemplary perspective view illustrating a battery used in the television receiver of the embodiment;

FIG. 20 is an exemplary exploded perspective view illustrating the portion to which the container is provided of the housing, the battery, and the cap of the television receiver in the embodiment;

FIG. 21 is an exemplary perspective cross-sectional view along line XXI-XXI of FIG. 3; and

FIG. 22 is an exemplary schematic cross-sectional view illustrating a state in which the battery is housed in the container of the housing of the television receiver in the embodiment.

### DETAILED DESCRIPTION

In general, according to one embodiment, a television receiver comprises: a display comprising a screen; a cover configured to cover at least a side of the display, the side opposite the screen; a mask configured to cover a periphery of the screen from a side opposite the cover; a middle frame between the mask and the cover, the middle frame configured to cover at least a peripheral edge of the display; two first supports configured to be provided integrally with the middle frame, each of the first supports comprising a protrusion protruding from a position on an edge of the middle frame on a short side direction side of the screen and closer to a central area than a corresponding edge of the middle frame in a long side direction of the screen; a second support configured to protrude from the cover so as to be separated from the two first supports; a battery configured to be housed in a detachable manner in a container between the two first supports and on an edge on a side of the two first supports of the cover, the container opening toward a side opposite the screen; and a covering portion configured to cover the container.

The following exemplary embodiment includes the same elements. The same elements are labeled with the same reference numerals and the duplicated descriptions are omitted. The accompanying drawings are illustrated with directions (the X direction, the Y direction, and the Z direction) for the sake of convenience. The X direction is a long side direction of a screen 4a when viewed from the front of the screen 4a (also referred to as in front view). The Y direction is a short side direction of the screen 4a in front view. The Z direction is a front-back direction (a depth direction or a thickness direction of a housing 3) in front view. The X, Y, and Z directions are orthogonal to each other.

In the following embodiment, a television receiver and a personal computer are described as the examples of an electronic apparatus. The electronic apparatus according to the embodiment, however, is not limited to the television receiver and the personal computer. Examples of the electronic apparatus according to the embodiment include various types of electronic apparatuses, such as smartphones, smartbooks, cellular phones, personal digital assistants (PDAs), image display devices, and videophone devices.

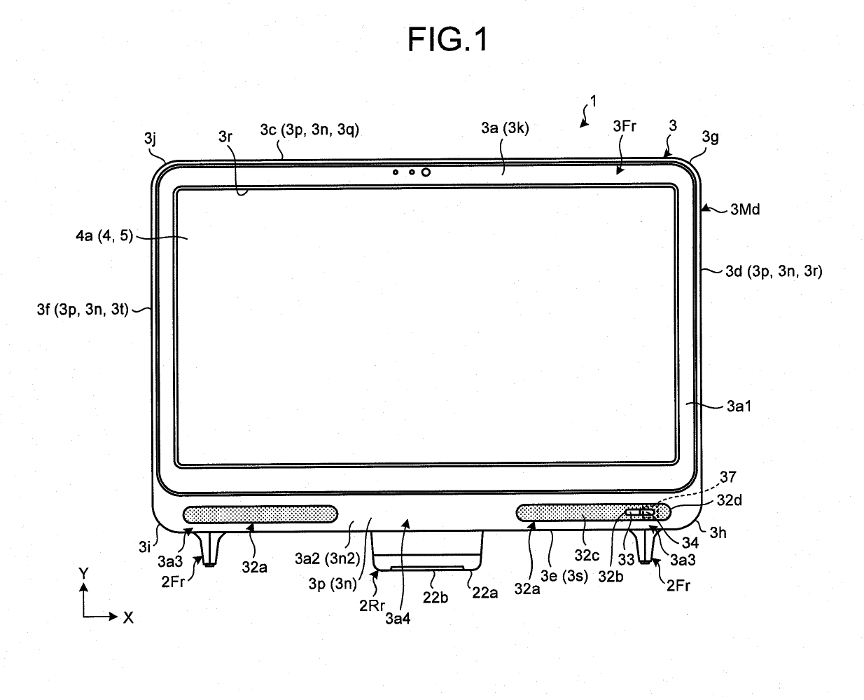

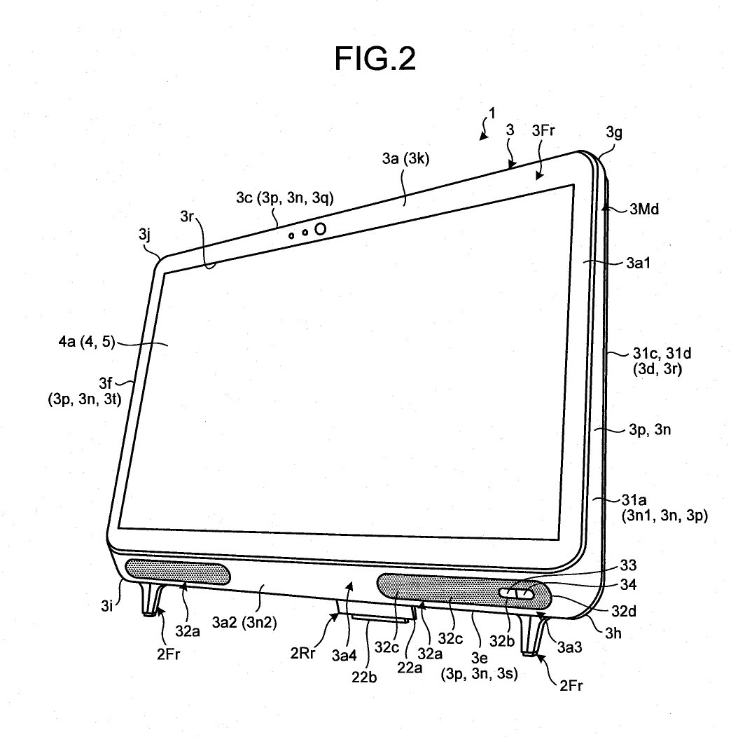

As illustrated in FIGS. 1 to 5, a television receiver 1, which is an example of the electronic apparatus according to the embodiment, comprises supports 2Fr and 2Rr (supports, tables, or stands), and the housing 3. The supports 2Fr and 2Rr are placed on a placement portion (not illustrated) of a desk, a rack, or a table, for example, and support the housing 3.

As illustrated in FIG. 1, the housing 3 has a quadrangular shape (in the embodiment, e.g., a rectangular shape) in front view. As illustrated in FIGS. 1 to 5, the housing 3 is structured in a flat rectangular parallelepiped shape having a small thickness in the front-back direction. The housing 3 has a front surface 3a (a front, a surface, a surface portion, or a front surface portion) and a back surface 3b (a rear, a surface, a surface portion, or a back surface portion) located opposite the front surface 3a. The front surface 3a is an example of a first front surface. As illustrated in FIG. 1, the housing 3 has four edges 3c to 3f (sides or frames) and four corners 3g to 3j (sharp edges, bended portions, or edges) in front view. The edges 3c and 3e are both edges of the housing 3 and a display 4 in the short side direction, and are examples of a long side. The edges 3d and 3f are both edges of the housing 3 and the display 4 (the screen 4a) in the long side direction, and are examples of a short side. The housing 3 is supported by the supports 2Fr and 2Rr in a standing state (posture).

The housing 3 has a wall 3k (a portion, a plate, a frame, a bezel, a front wall, a frontward wall, or a ceiling wall) including a front surface 3a1, and a wall 3m (a portion, a plate, aback wall, a backward wall, or a bottom wall) including the back surface 3b. The front surface 3a1 is a part of the front surface 3a of the housing 3. The front surface 3a1 and the back surface 3b are nearly parallel to each other. The walls 3k and 3m have quadrangular shapes (in the embodiment, e.g., rectangular shapes). The housing 3 has four walls 3n (portions, plates, side walls, edge walls, upright walls, or extending portions) including an extending surface 3p (a circumferential surface, a surface, or a surface portion) that extends between the walls 3k and 3m. At least a part of the extending surface 3p forms a side surface of the housing 3. The wall 3k is provided with an opening 3r having a quadrangular shape (in the embodiment, e.g., a rectangular shape). That is, the opening 3r is provided to the front surface 3a. The opening 3r is an example of a first opening.

The housing 3 can be structured by combining a plurality of parts (divided bodies or members). For example, the housing 3 comprises a first member 3Rr, a second member 3Md, and a third member 3Fr. The first member 3Rr (a first portion, a back side member, a base, a bottom, a back cover, a cover, a housing, a first housing member, a casing, an external wall, a reinforcement, or a support) comprises at least the wall 3m. The second member 3Md (a second portion, an intermediate member, a frame, a middle frame, a middle cover, a middle frame member, a housing, a second housing member, a reinforcement, amount portion, a support, or a support) comprises at least the walls 3n. The third member 3Fr (a third portion, a front side member, a bezel, a front cover, a masking member, a housing, a third housing member, a casing, a cover, an external wall, a reinforcement, or a support) comprises at least the wall 3k. The housing 3 can be made by a synthetic resin material or a metal material, for example. The second member 3Md has a higher stiffness than that of the third member 3Fr and a larger outer edge dimension than that of the third member 3Fr.

In the embodiment, as exemplarily illustrated in FIG. 1, the wall 3k of the third member 3Fr is formed in a frame and platy shape having a quadrangular shape (e.g., a rectangular shape) and covers a rim (outer circumference) of the display 4. The rim of the display 4 comprises the long sides and short sides of the display 4. The rim of the display 4 has a quadrangular shape when viewed from the rear (also referred to as in rear view). The display 4 (a display portion, a display, or a panel) is housed inside the housing 3 surrounding the rim of the display 4. The screen 4a, which is located on the front surface 3a side of the display 4, is exposed through the opening 3r in a forward (outward) direction of the housing 3. A user can view the screen 4a through the opening 3r from the front side of the housing 3. That is, the screen 4a of the display 4 is exposed by providing the opening 3r. The display 4 has a quadrangular shape (in the embodiment, e.g., a rectangular shape) in front view. The display 4 is formed in a flat rectangular parallelepiped shape having a small thickness in the front-back direction. The display 4 may be a liquid crystal display (LCD) or an organic electroluminescent display (OLED), for example. In the embodiment, the display 4 is attached to the second member 3Md, for example. Joints (e.g., screws) and brackets (clamps), which are not illustrated, can be used for attaching the display 4 to the second member 3Md.

An input operation panel 5 (e.g., a touch panel, a touch sensor, or an operation surface) having a relatively small thickness and a quadrangular shape (in the embodiment, e.g., a rectangular shape) and being transparent is disposed on a forward side (a frontward side or the wall 3k side) of the display 4, for example. The input operation panel 5 covers the screen 4a. An operator (or a user) can perform input processing through operations such as touching, pressing, and rubbing the input operation panel 5 with fingers or a stylus, or moving fingers or the stylus near the input operation panel 5, for example. Light emitted from the screen 4a of the display 4 passes through the input operation panel 5 and travels in the forward (outward) direction from the housing 3 through the opening 3r provided to the wall 3k. The input operation panel 5 is an example of an input module.

In the embodiment, as exemplarily illustrated in FIG. 1, the second member 3Md is formed in a quadrangular frame shape (a ring-like shape) in front view. The second member 3Md has four edges 3q to 3t (sides or frames) in front view. The edges 3q to 3r serve as material portions of the second member 3Md. The edges 3q and 3s are both edges of the second member 3Md and the display 4 (the screen 4a) in the short side direction and are examples of the long side. The edges 3q and 3s are shaped so as to extend in the long side direction of the display 4. The edges 3r and 3t are both edges of the second member 3Md and the display 4 (the screen 4a) in the long side direction and are examples of the short side. The edges 3r and 3t are shaped so as to extend in the short side direction of the display 4. The edges 3r and 3t are portions to which the display 4 is attached (mounted), for example. The connections (joints) of four edges 3q to 3t are curved. That is, the edges 3q to 3t comprise the curved portions. Therefore, the edges 3d and 3f are portions to which the display 4 is attached (mounted). The connections (joints) of the four edges 3c to 3f are curved. The edges 3c to 3f, thus, comprise the curved portions. In the embodiment, as exemplarily illustrated in FIG. 1, the second member 3Md surrounds the third member 3Fr. At least in front view, a color, a glossiness level, a surface condition, ridges and valleys, and surface roughness, for example, differ between the third member 3Fr and the second member 3Md, so that the third member 3Fr and the second member 3Md are readily identified from each other due to the differences in their outer appearances. The width of the second member 3Md is narrower than that of the third member 3Fr at the edge 3c located in an upper direction (upper side) and at the edges 3d and 3f located in a side direction (at both left and right sides), in front view.

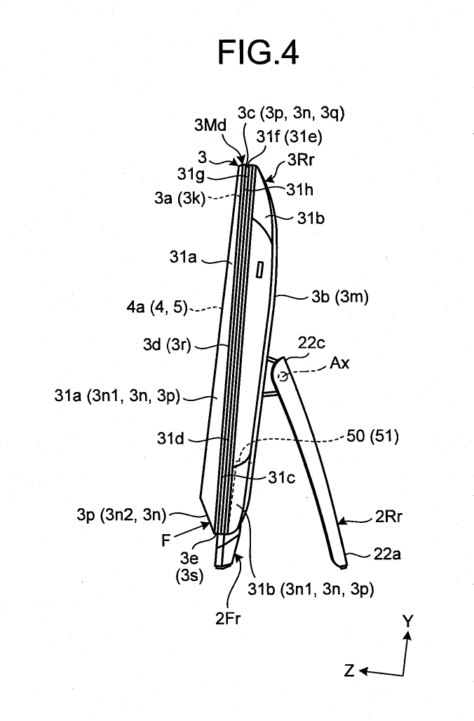

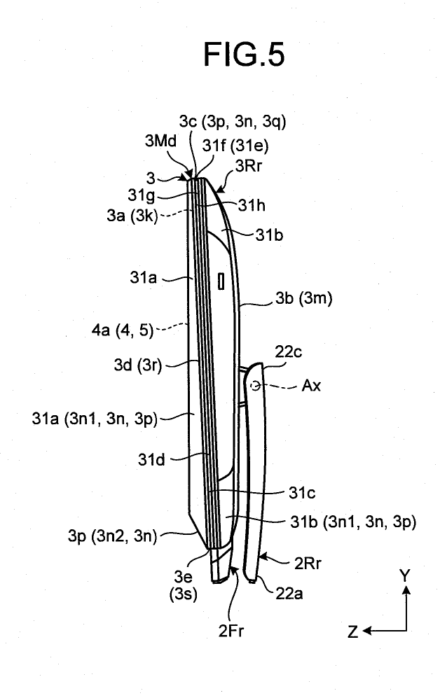

In the embodiment, as exemplarily illustrated in FIGS. 4 and 5, walls 3n1 (side walls) located at both sides in the long side direction of the display 4 in the wall 3n comprise front sections 31a (sections, regions, or walls) comprised in the second member 3Md and back sections 31b (sections, regions, or walls) comprised in the first member 3Rr. The front section 31a is formed in a triangle shape narrowing (sharpening) toward the upper side. That is, the width of the front section 31a is gradually narrowed (reduced or thinned) from the edge 3e side (one edge side or a lower side) toward the edge 3c side (the other edge side or the upper side) opposite the edge 3e of the housing 3. An edge 31c, which is located on a side opposite the screen 4a (on a backward direction side or the right side in FIGS. 4 and 5), of the front section 31a is formed in a straight line manner. The back sections 31b (second walls) extend toward a central area when viewed from the front of the screen 4a as the back sections 31b extend from an edge 31d meeting the edge 31c toward a side opposite the screen 4a (the backward direction side, or from the left side to the right side in FIGS. 4 and 5). In the embodiment, the wall 3m of the housing 3 bulges (curves) toward the backward direction side and sections (edges) located at both ends in the long side direction of the wall 3m serve as the back sections 31b of the walls 3n1.

In the embodiment, as exemplarily illustrated in FIGS. 1, 2, 4, and 5, a wall 3n2 located on one end side (a lower end side) of the display 4 in the short side direction in the walls 3n is a part of the second member 3Md. At least a part of the extending surface 3p provided as the wall 3n2 is a front surface 3a2 (a surface) of the wall 3n2. The front surface 3a2 of the wall 3n2 is a part of the front surface 3a of the housing 3 and forms the front surface 3a of the housing 3 together with the front surface 3a1 of the wall 3k. The wall 3n2 extends from a side away from the screen 4a (a lower direction side) toward a side close to the screen 4a (an upper direction side) when viewed from the front of the screen 4a as the wall 3n2 extends from the backward direction side (a rear side, a behind side, a side opposite the screen 4a, or the right side in FIGS. 4 and 5) to the forward direction side (the front side, the screen 4a side, or the left side in FIGS. 4 and 5). That is, the wall 3n2 (the front surface 3a2 thereof) is slanted with respect to a direction along the screen 4a and the normal line direction of the screen 4a. The front surface 3a2 is an example of a slanted surface slanted with respect to the screen 4a.

In the embodiment, as exemplarily illustrated in FIGS. 4 to 7, the walls 3n are provided with a groove 31e (a groove or a recess). The groove 31e extends along a border line 31i (a border area or a border, refer to FIG. 7) between the first member 3Rr and the second member 3Md. The groove 31e has a bottom surface 31f (a bottom portion, a bottom, a surface, or a portion) and opposing surfaces 31g and 31h extended from the bottom surface 31f as a pair. The bottom surface 31f and the opposing surface 31g, which is one of the pair, are provided to the first member 3Rr. The opposing surface 31h, which is the other of the pair, is provided to the second member 3Md. The border line 31i (refer to FIG. 7) is located in the groove 31e. In the embodiment, the border line 31i is provided to the border (border area) between the bottom surface 31f and the opposing surface 31g.

In the embodiment, as exemplarily illustrated in FIG. 1, the first supports 2Fr are provided to the edge 3e (the one edge, the long side, or the lower side) of the housing 3 in the short side direction of the screen 4a, and supports the housing 3. Specifically, the two first supports 2Fr are located in the long side direction (an extending direction of the edge 3e) of the screen 4a with a distance therebetween, protrude from the edge 3e (the one edge, the long side, or the lower side) of the housing 3 in the short side direction of the screen 4a, and support the housing 3. The two first supports 2Fr protrude toward a lower direction (the opposite direction of the direction toward the edge 3c) from positions, which are closer to the central area than both edges (the corners 3h and 3i) in the long side direction (the X direction, the with direction of the screen 4a, or the left-right direction), on the edge 3e (the one edge, the long side, or the lower side) of the housing 3 in the short side direction (the Y direction or the short side direction of the screen 4a). In the embodiment, as exemplarily illustrated in FIGS. 1 to 5, the second support 2Rr protrudes from the first member 3Rr so as to be apart from the two first supports 2Fr. The second support 2Rr protrudes from a position between the two first supports 2Fr when viewed from the front of the screen 4a and supports the housing 3 at three points together with the two first supports 2Fr.

In the embodiment, as exemplarily illustrated in FIG. 4, the first supports 2Fr protrude in a direction along the edge 31c located on the side opposite the screen 4a of the front section 31a (the backward direction side or the right side in FIG. 4).

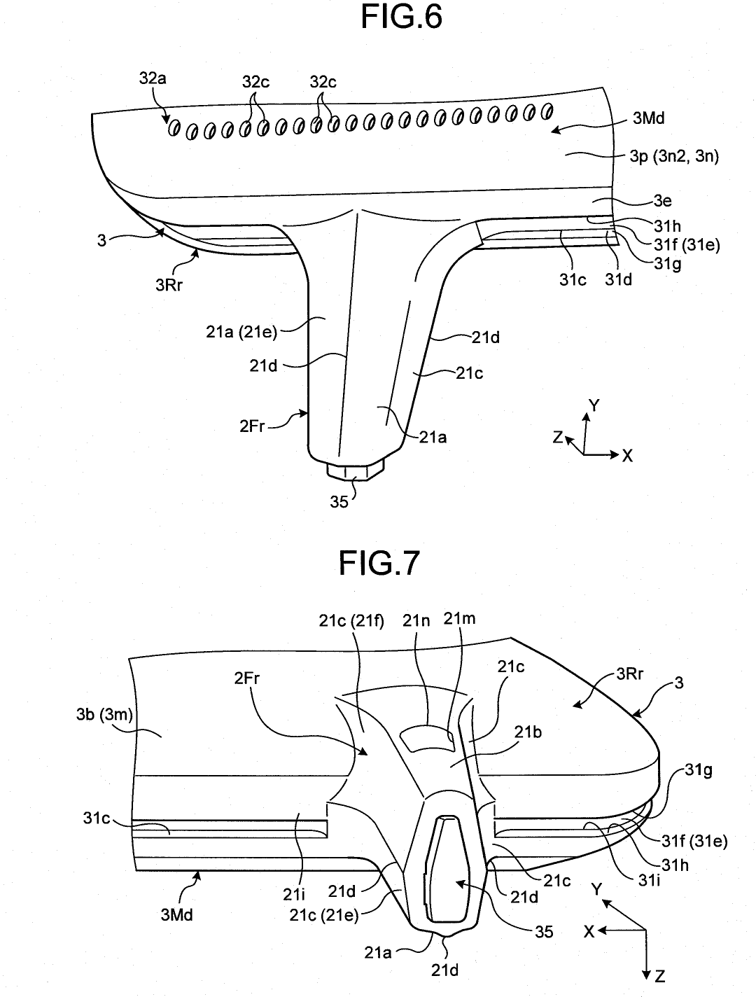

In the embodiment, as exemplarily illustrated in FIGS. 1 to 4 and 6, the first supports 2Fr have a taper shape. That is, each of the first supports 2Fr has a shape tapered from a root portion to a tip thereof. In the embodiment, as can be seen from FIGS. 6 and 7, a front surface 21a, a back surface 21b, and two side surfaces 21c of the first supports 2Fr respectively bulge outward, for example. Ridge lines 21d extending from the root portion to the tip of the first support 2Fr are formed on the central areas of the front surface 21a and the two side surfaces 21c. The ridge lines 21d on the front surface 21a and the two side surfaces 21c bulge outward more than the other areas. The front surface 21a is an example of a second front surface.

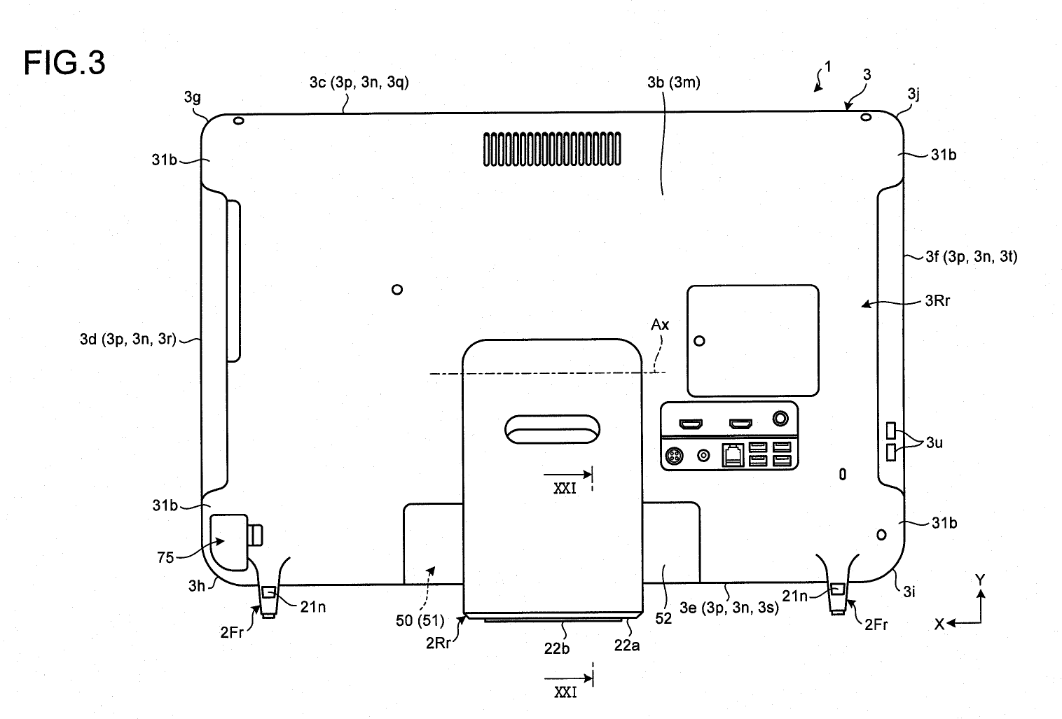

In the embodiment, as exemplarily illustrated in FIG. 9, the first support 2Fr comprises a protrusion 21e (a first protrusion) provided to the second member 3Md and a protrusion 21f (a third protrusion) provided to the first member 3Rr. Specifically, the protrusion 21e protrudes toward the lower direction from the edge 3e of the second member 3Md (a side opposite the edge 3c) and also protrudes backward (on a side opposite the screen 4a) with respect to the edge 31c. The protrusion 21e has a first portion 21g located on a side opposite the screen 4a (the backward direction side) with respect to the edge 31c. The protrusion 21e is formed in a protruded shape (a convex shape or a projected shape). The base (the root portion) of the protrusion 21e is located near a speaker 38. The protrusion 21f protrudes toward the lower direction along the protrusion 21e from the wall 3m (the back wall) of the first member 3Rr and the wall 3n (the side wall). The protrusion 21f is formed in a protruded shape (a convex shape or a projected shape). The base (the root portion) of the protrusion 21f is located near the speaker 38. The first member 3Rr is provided with a notch 21h that receives the first portion 21g, which is located on the backward direction side with respect to the edge 31c, of the protrusion 21e. That is, a second portion 21i next to the notch 21h of the first member 3Rr is located opposite the tip of the first portion 21g and makes contact with the first portion 21g. The protrusion 21e and the protrusion 21f thus structured are put together in the front-back direction and integrated, thereby structuring the first support 2Fr. The protrusion 21f is provided with an opening 21j. The protrusion 21e is provided with a joint portion 21k (e.g., a female screw hole, not illustrated) to which a joint (e.g., a screw, not illustrated) put through the opening 21j is jointed. That is, the protrusion 21e and the protrusion 21f are jointed by the joint. A recess 21m is provided at the edge of the opening 21j. A cap 21n (refer to FIGS. 3 and 7) is placed in the recess 21m and covers the recess 21m and the opening 21j. The cap 21n is made of a material having elasticity and flexibility such as elastomer.

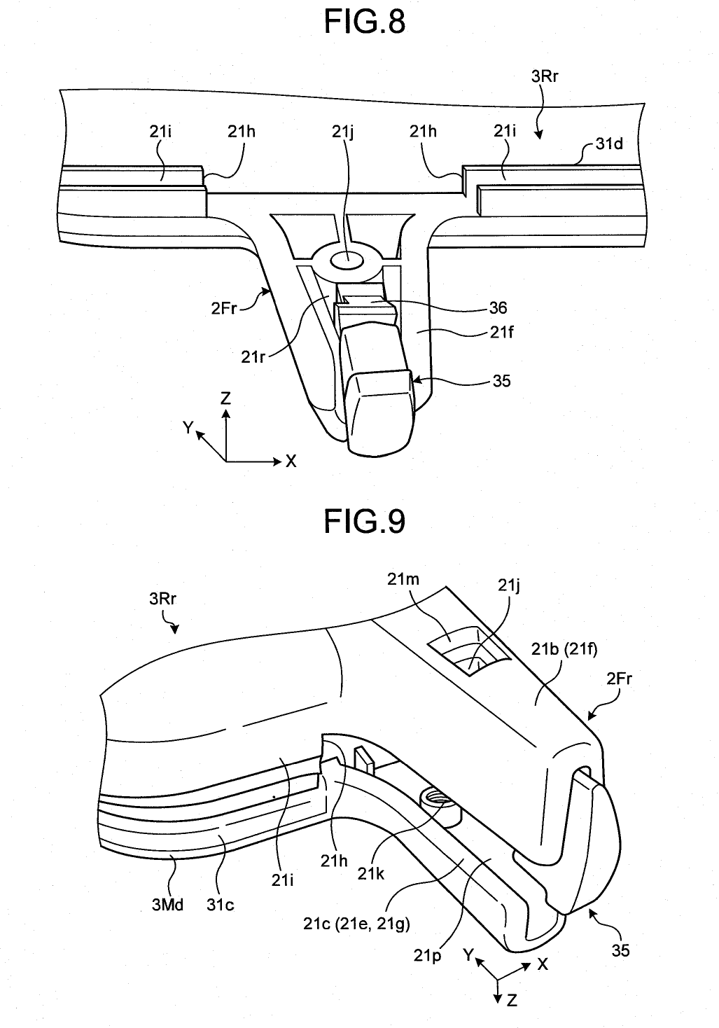

In the embodiment, as exemplarily illustrated in FIGS. 8 and 9, an elastic member 35 having flexibility and elasticity is sandwiched between the protrusion 21e and the protrusion 21f. The elastic member 35 is housed in a recess 21p provided to the protrusion 21e and a recess 21r provided to the protrusion 21f. The elastic member 35 is exposed (protruded) on a tip side (the lower direction side) of the first support 2Fr. As illustrated in FIG. 8, a buffer member 36 having flexibility is located on a root portion side (on the upper side) of the elastic member 35. The buffer member 36 is interposed between the elastic member 35 and the first support 2Fr. The elastic member 35 is made of elastomer, for example. The buffer member 36 is made of a foamed material of a synthetic resin material, for example.

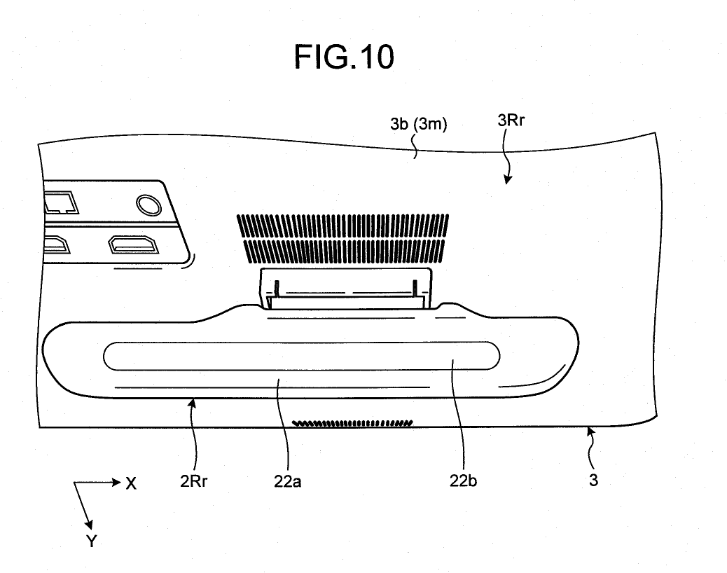

In the embodiment, as exemplarily illustrated in FIGS. 1, 3, and 10, the second support 2Rr has a quadrangular shape (e.g., a rectangular shape) having a width in the long side direction of the housing 3 (the display 4) and a platy shape. As illustrated in FIG. 10, an edge 22a is formed in an elongate surface extending along the long side direction of the housing 3 (the display 4). The edge 22a is provided with an elastic member 22b extending along the long side direction of the edge 22a. The elastic member 22b protrudes from the edge 22a on the tip side of the second support 2Rr (on the lower direction side).

In the embodiment, as exemplarily illustrated in FIGS. 4 and 5, the second support 2Rr is rotatably supported by the wall 3m of the housing 3. The second support 2Rr is coupled to the wall 3m with a hinge mechanism (not illustrated) interposed therebetween. The hinge mechanism has two parts linked rotatably around a rotation axis Ax illustrated in FIGS. 3 to 5. The rotation axis Ax is located at the central area of the wall 3m and an edge 22c opposite the edge 22a of the second support 2Rr, and extends along the edge 22a (the long side direction or the left-right direction of the housing 3 and the display 4) and the back surface 3b of the wall 3m. FIG. 4 illustrates a state in which the second support 2Rr is projected (an unfolded state) while FIG. 5 illustrates a state in which the second support 2Rr is retracted (a folded state). As can be seen from FIG. 4, when the housing 3 is supported in a standing posture by the first supports 2Fr and the second support 2Rr having been unfolded, the first supports 2Fr slant toward the front side from the back side as they extend from the upper side toward the lower side while the second support 2Rr slants toward the back side from the front side as it extends from the upper side toward the lower side.

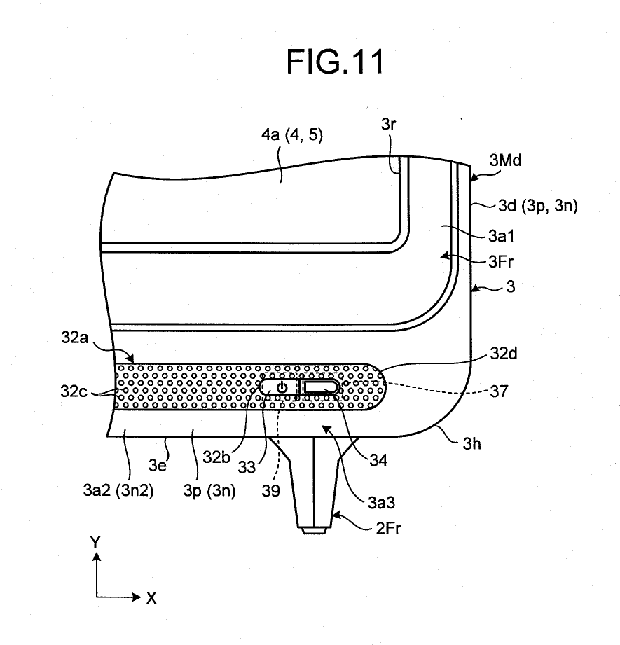

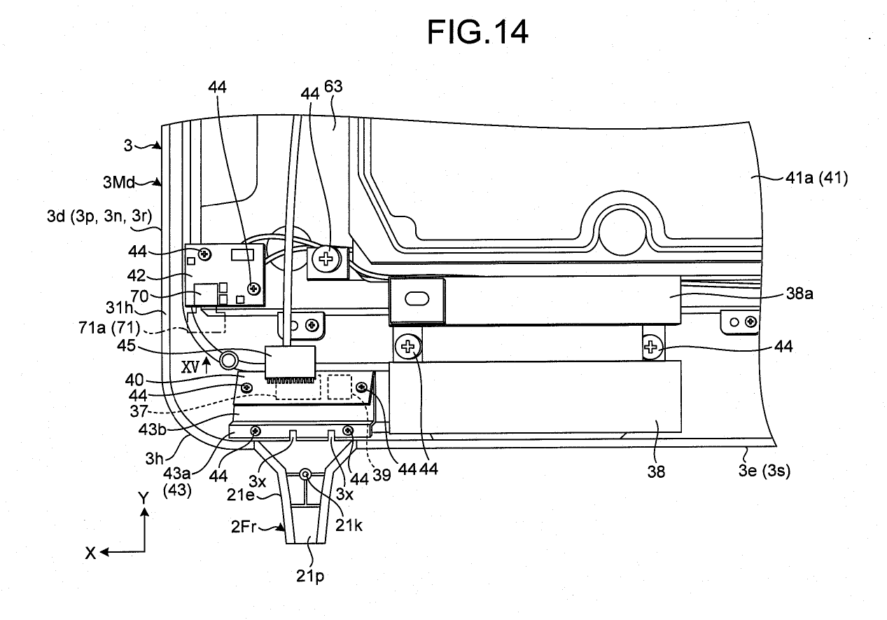

As illustrated in FIGS. 1 and 11, the wall 3n2 is provided with openings 32a and 32b. That is, the front surface 3a2 (the slanted surface) of the wall 3n2 is provided with the openings 32a and 32b. The opening 32b is an example of a second opening. The two openings 32a are provided so as to be opposite each other with a distance therebetween in the long side direction of the screen 4a. The opening 32a comprises a plurality of small holes 32c (holes or through holes, refer to FIG. 6). The speaker 38 (a housed part, refer to FIG. 14) is provided behind the region in which the opening 32a is provided. A voice (sound) from the speaker 38 is output through the opening 32a (the small holes 32c). FIG. 14 illustrates the speaker 38 provided corresponding to one of the openings 32a serving as third openings. In this way, the front surface 3a2 is provided with the small holes 32c through which sounds are output. The small holes 32c are examples of a third opening. As illustrated in FIG. 1, the openings 32a, which serve as regions having the small holes 32c, are formed on the left and the right sides in front view in a long hole shape extending along the edge 3e. The length of the opening 32a is approximately one-third of that of the edge 3e. The opening 32b is provided in the opening 32a serving as the region having small holes 32c on the front surface 3a (the front surface 3a1). The opening 32b is located so as to be close to one edge 32d of the opening 32a (the region) in the long side direction of the screen 4a. The opening 32b is located so as to be closer to the edge 3d than the edge 3f.

In the embodiment, as exemplarily illustrated in FIGS. 1 and 11, an operation element 33 of a switch 39 (a housed part) and a cover 34 of a communications module 37 (a housed part, e.g., an infrared rays receiver) are exposed through the opening 32b. The cover 34 is an example of another part different from the operation element 33. In this way, the operation element 33 and the cover 34, which is a part different from the operation element 33, are exposed through the opening 32b. The operation element 33 is an example of an operation module. The switch 39 can be structured as a so-called push-push type push-button switch, which switches on and off each time when the operation element 33 is pressed, for example. The operation element 33 is pressed along a direction (direction indicated with an arrow F in FIG. 4) approximately perpendicular to the front surface 3a2. The switch 39 can be structured as a power source switch, for example. The operation element 33 has a sign indicating that the switch is the power source switch on a surface thereof, for example. The operation element 33 is not limited to being provided to the switch 39. For example, the operation element 33 may be provided to an adjustor that adjusts brightness of the screen 4a, for example. The communications module 37 can be structured as a light receiving module of infrared rays (infrared light), for example. The opening 32b is provided to a section 3a3 (a first section, a first region, or a region) located on the front surface 3a (the front surface 3a2) and on the housing 3 side of one of the first supports 2Fr in the short side direction of the screen 4a. That is, the opening 32b is located on the upper side of one of the first supports 2Fr. Therefore, the operation element 33 and the cover 34 are also located on the upper side of one of the first supports 2Fr.

The opening 32b is not limited to being located at the above-mentioned position. For example, the opening 32b may be provided to the front surface 21a and the operation element 33 may be exposed through the opening 32b. As another example, the opening 32b may be provided to a section 3a4 located between the first supports 2Fr and on the housing 3 side in the short side direction of the screen 4a, and the operation element 33 may be exposed through the opening 32b. As still another example, the opening 32b may be located between the first supports 2Fr, which are located axisymmetric about the center line (virtual) passing through the center of the screen 4a in the long side direction as a pair. In other words, the opening 32b may be eccentrically located from the center line in the long side direction of the screen 4a between the first supports 2Fr so as to be close to the center line of the housing 3 in the long side direction of the screen 4a. As can be seen from the above, the opening 32b through which the operation element 33 is exposed, may be provided to any of the section 3a3 on the front surface 3a, the section 3a4 located on the front surface 3a between the first supports 2Fr and on the housing 3 side in the short side direction of the screen 4a, and the front surface 21a.

In the embodiment, as exemplarily illustrated in FIGS. 1 and 11, the operation element 33 is located between the screen 4a and one of the first supports 2Fr (e.g., the first support 2Fr located at the right side in FIG. 1) in the short side direction of the screen 4a. In the embodiment, the operation element 33 is located forward from the first support 2Fr (on the screen 4a side), for example. In the embodiment, the operation element 33 is attached to the second member 3Md, for example. The operation element 33 is attached to the second member 3Md together with the switch 39 with a linking member interposed therebetween, for example. In the embodiment, the operation element 33 is located so as to be closer to the center of the opening 3r (the first opening) than the cover 34 (the other part) in the long side direction of the screen 4a, for example.

In the embodiment, as exemplarily illustrated in FIG. 14, the housing 3 houses a circuit board 40 (a board or a housed part). On a front surface (a mount surface, one surface, or a surface) of the circuit board 40, the switch 39 provided with the operation element 33 (e.g., a power source switch) and the communications module 37 are mounted. On a back surface 40a (another surface or a surface) of the circuit board 40, a connector 45 is provided. The circuit board 40 is attached to the second member 3Md with a supporting member 43 (an attachment member, an interposed member, or a sheet-metal member) interposed therebetween. The circuit board 40 (the front surface and the back surface 40a thereof) is located along the front surface 3a2 (the slanted surface) and slanted with respect to the screen 4a. The circuit board 40 is attached to the second member 3Md by joints 44 (screws) while the supporting member 43 is attached to the second member 3Md by the joints 44 (the screws), for example. The supporting member 43 has a base 43a and a platy portion 43b (an attaching portion) extended from the base 43a. The circuit board 40 is attached to the platy portion 43b. The platy portion 43b (a part thereof) is located between the second member 3Md and the circuit board 40. The supporting member 43 supports the operation element 33 by an engaging portion (a support or an arm, not illustrated) so as to be able to be displaced (to be able to reciprocate, to be able to move toward and away from, or to be operable). The supporting member 43 engages with engaging portions (clicks) 3x provided to the second member 3Md, for example. The circuit board 40 is located behind (on a rear side of) the opening 32b. The circuit board 40 is located on the upper side of the first support 2Fr and on the lower side of the display 4. That is, the circuit board 40 is located between the first support 2Fr and the display 4. The circuit board 40 and the speaker 38 are located side by side in the long side direction of the screen 4a. The speaker 38 is attached to the second member 3Md by the joints 44 (the screws). One edge 38a (an upper edge, an edge, or an edge portion) of the speaker 38 is located behind the display 4.

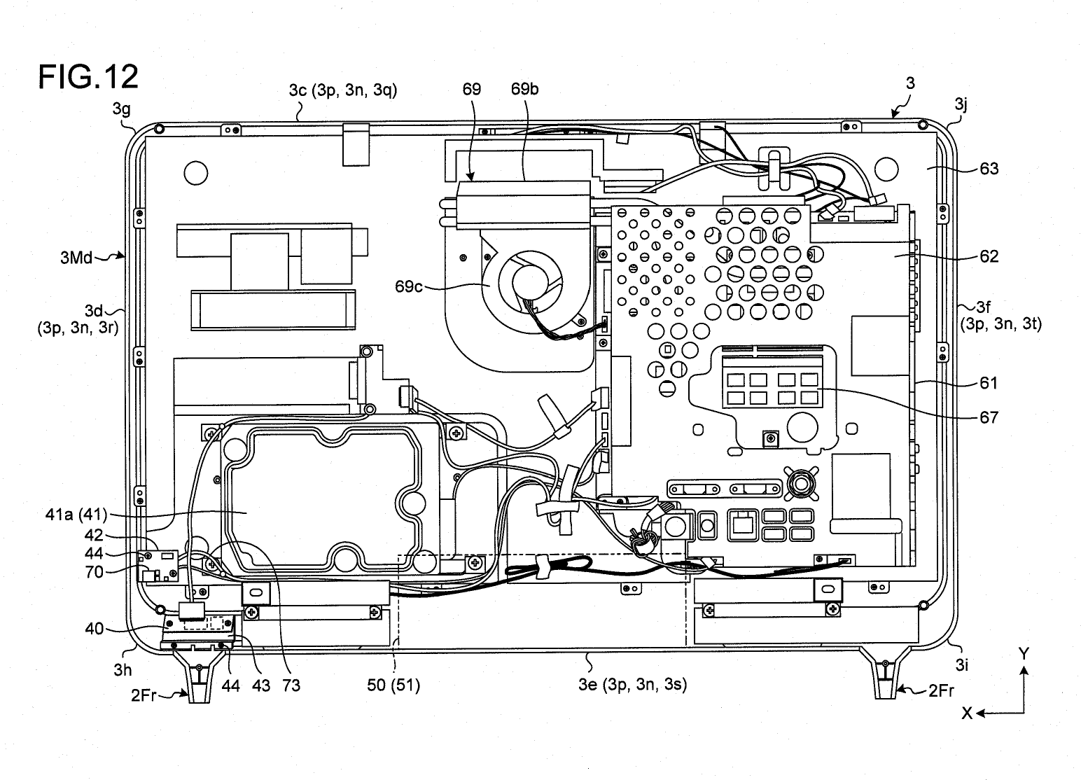

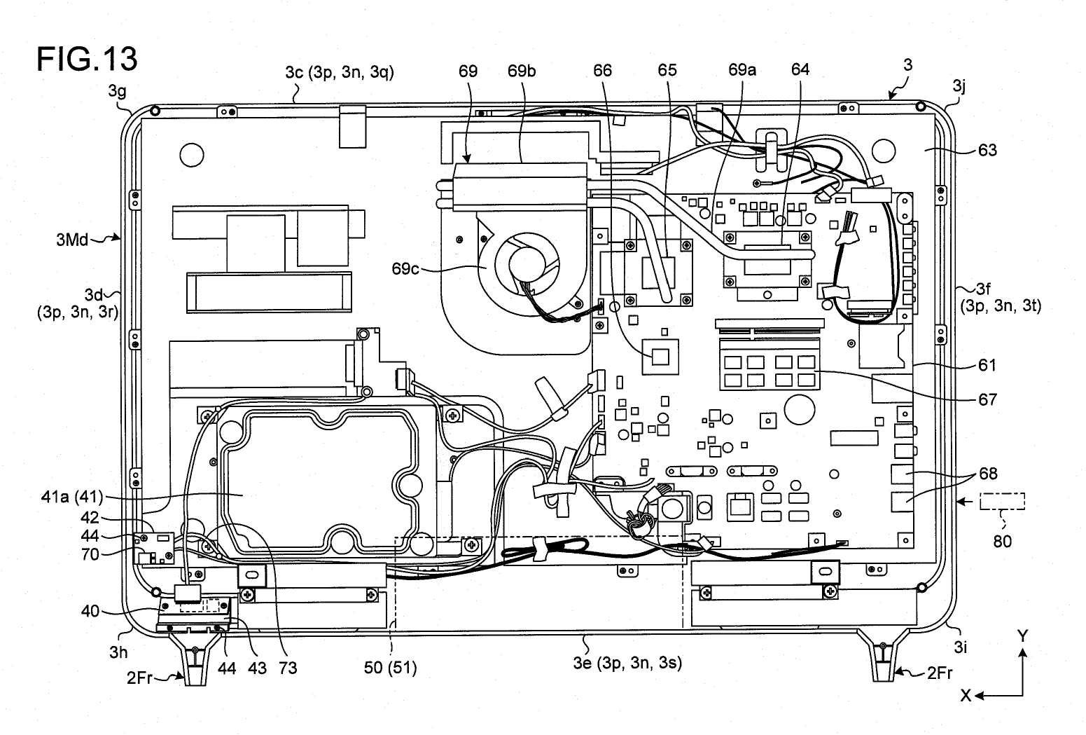

In the embodiment, as exemplarily illustrated in FIGS. 12 and 13, the housing 3 houses a circuit board 61 (a board, a control board, a main boar, or a housed part) different from the circuit board 40 on the back side (a rear side, a behind side, the wall 3m side, or a side opposite the screen 4a) of the display 4. The circuit board 61 is provided under the display 4 so as to be overlapped. At least a part of the back side (the rear side, the behind side, the wall 3m side, or the side opposite the screen 4a) of the circuit board 61 is covered by a cover 62 (refer to FIG. 12). The cover 62 is fixed to the circuit board 61 or the housing 3 by fixtures such as screws. The circuit board 61 is disposed apart from the walls 3k, 3m, and 3n, i.e., so as to provide spaces between itself and the walls 3k, 3m, and 3n. In the embodiment, the back side (the rear side, the behind side, the wall 3m side, or the side opposite the screen 4a) of the display 4 is covered by a wall 63 (a wall member, a wall, a platy member, a shielding member, or a masking member), for example. That is, the wall 63 is located on a side opposite the screen 4a of the display 4. The wall 63 is located between the display 4 and the first member 3Rr. The circuit board 61 is fixed to the display 4 or the housing 3 by fixtures such as screws. The circuit board 61 may be fixed to the display 4 with the wall 63 interposed therebetween, for example. The circuit board 61 is located so as to be closer to the edge 3t (the edge 3f) than the edge 3r (the edge 3d). The circuit board 61 is an example of a first circuit board.

In the embodiment, as exemplarily illustrated in FIG. 13, on the circuit board 61, a plurality of electronic parts (parts or elements) are mounted, such as a central processing unit (CPU) 64, a graphic controller 65, a platform controller hub (PCH) 66, a storage device 67, a connector 68 (an electrical part, an electronic part, a connection module, a joint module, a conduction module, a connection part, or apart). Examples of the electronic part include a heating element. The CPU 64 and the graphic controller 65, which are electronic parts producing huge heat (heating elements), are provided with a cooling mechanism 69 (a heat dissipation module or a heat receiving module). The cooling mechanism 69 comprises a heat pipe 69a, a heat sink 69b, and a cooling fan 69c. The circuit board 61 and the electronic parts mounted on the circuit board 61 format least a part of a control circuit (not illustrated). The control circuit can comprise a video signal processing circuit, a tuner, a high-definition multimedia interface (HMDI) signal processor, an audio video (AV) input terminal, a remote controller signal receiver, a controller, a selector, an on screen display interface, a storage such as a read only memory (ROM), a random access memory (RAM), and a hard disk drive (HDD), and a voice signal processing circuit. FIG. 13, for example, illustrates an HDD 41 (an electronic part or a housed part) as an example of the storage. The control circuit controls output of images (moving images and still images) on the screen 4a of the display 4, output of voices from the speakers 38, and A light emission of a light emitting diode (LED) (not illustrated). The display 4, the speakers 38, and the LED are examples of an output module.

The connector 68 is compliant with a universal serial bus (USB) standard, for example. The connector 68 is located so as to be closer to the edge 3t (the edge 3f) than the edge 3r (the edge 3d), for example. The edge 3t (and the edge 3f) is an example of a first edge while the edge 3r (and the edge 3d) is an example of a second edge located opposite the first edge. The connector 68 is located so as to be closer to the edge 3t (the edge 3f) than the edge 3r (the edge 3d). The connector 68 is located at a position close to one of the two first supports 2Fr (one located on the right side when viewed from the rear of the housing 3). The connector 68 is located near one of the two first supports 2Fr (one located on the right side when viewed from the rear of the housing 3). The connector 68 is located near the storage device 67. The connector 68 is located so as to be closer to the storage device 67 than the HDD 41. The connector 68 is exposed through openings 3u (refer to FIG. 3) provided to the third member 3Fr. The connector 68 is used for data communications, for example. The connector 68 can be connected to an external apparatus 80 in a detachable manner. The external apparatus 80 is a storage device, for example.

In the embodiment, as exemplarily illustrated in FIGS. 13 and 14, the HDD 41 (the electronic part) is housed in the housing 3 at a position on the back side (the rear side, the behind side, the wall 3m side, or the side opposite the screen 4a) of the display 4, for example. The HDD 41 is located on the upper side of (on the edge 3c side of the housing 3) the speaker 38 and jointed (fixed) to the wall 63 by the joints 44 (the screws), for example. The HDD 41 is located so as to be closer to the edge 3r (the edge 3d) than the edge 3t (the edge 3f), for example. The HDD 41 is located at a position closer to the edge 3r (the edge 3d) than the edge 3t (the edge 3f). The HDD 41 is located between the connector 68 and a connector 70. The HDD 41 is located so as to be closer to the connector 70 than the connector 68. The HDD 41 is located at a position closer to the connector 70 than the connector 68. The HDD 41 is located near the connector 70. The HDD 41 is located at a position close to the other one of the two first supports 2Fr (one located on the left side when viewed from the rear of the housing 3). The connector 68 is located near the other one of the two first supports 2Fr (one located on the left side when viewed from the rear of the housing 3). The HDD 41 neighbors (makes contact with) one of the pair of speakers 38 (located on the left side when viewed from the rear of the housing 3). The HDD 41 has a housing 41a housing a hard disk. The housing 41a has an electromagnetic wave shielding property. The housing 41a is made of metal, for example.

In the embodiment, a circuit board 42 (a board or a housed part) is located in the vicinity of the HDD 41. On the circuit board 42, the connector 70 (the electrical part, the electronic part, the connection module, the joint module, the conduction module, or the part) for a wireless communications device 71 (en electronic apparatus, a receiver, a part, a module, an antenna, a communications module, or a device, refer to FIG. 14) is mounted. The connector 70 is an example of a second connector while the circuit board 42 is an example of a second circuit board. The circuit board 42 has a quadrangular shape in rear view. The circuit board 42 is smaller than the circuit board 61 in size. The circuit board 42 and the connector 70 are located at a position on the back side (the rear side, the behind side, the wall 3m side, or the side opposite the screen 4a) of the display 4 and housed in the housing 3. The circuit board 42 and the connector 70 are located on the upper side of the circuit board 40 (on the edge 3c side of the housing 3), for example. The circuit board 42 and the connector 70 are located so as to be closer to the edge 3r (the edge 3d) than the edge 3t (the edge 3f). The circuit board 42 and the connector 70 are located at a position closer to the edge 3r (the edge 3d) than the edge 3t (the edge 3f). The circuit board 42 and the connector 70 are located at a position close to the other one of the two first supports 2Fr (one located on the left side when viewed from the rear of the housing 3). The circuit board 42 and the connector 70 are located near the other one of the two first supports 2Fr (one located on the left side when viewed from the rear of the housing 3). The circuit board 42 and the connector 70 are located near the HDD 41. The circuit board 42 and the connector 70 are located at a position closer to the HDD 41 than the storage device 67. The circuit board 42 is attached to (fixed to) the wall 63 on a side opposite the display 4 of the wall 63 by the joints 44 (the screws), for example.

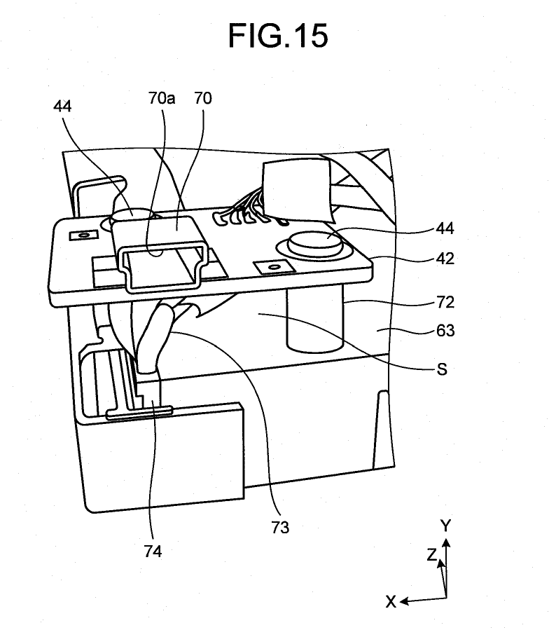

In the embodiment, as illustrated in FIG. 15, a boss 72 is provided between the circuit board 42 and the wall 63, so that the circuit board 42 is apart from the wall 63. A space S is provided between the circuit board 42 and the wall 63. In the space S, a wiring line 73 is provided. A connector 74 is provided to an end of the wiring line 73 and connected to the display 4, for example.

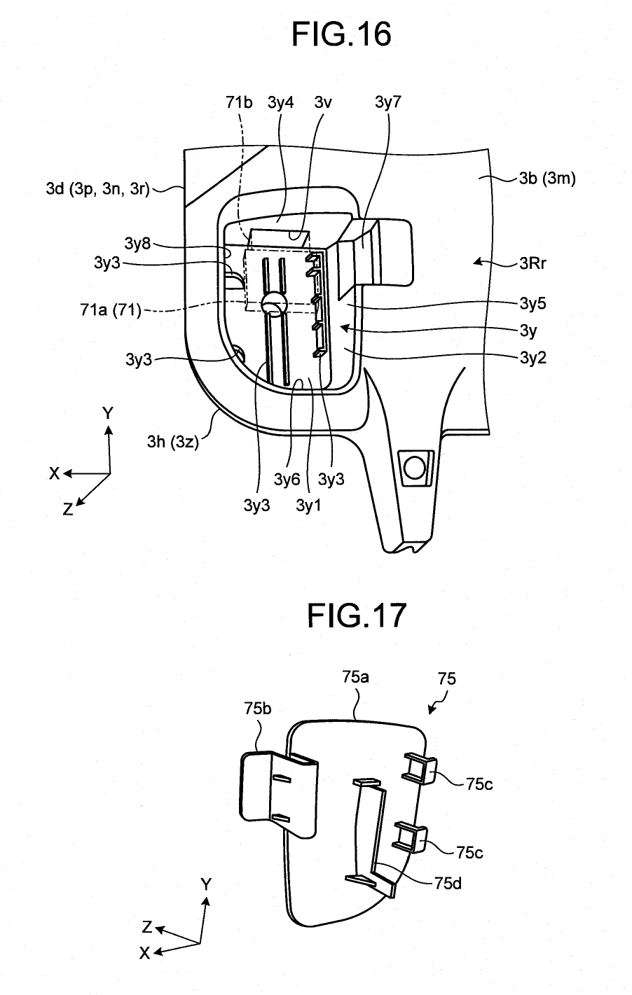

The connector 70 (a dongle connector) can be attached to the wireless communications device 71 in a detachable manner. An attachment inlet 70a (an opening or an insertion inlet, refer to FIG. 15) of the connector 70 opens toward the lower direction and is exposed through an opening 3v (refer to FIG. 16) provided to the third member 3Fr. Accordingly, the wireless communications device 71 can be attached to the connector 70 from below.

The wireless communications device 71 is a dongle, for example. As illustrated in FIG. 16, the wireless communications device 71 has a main body 71a including an antenna and an engaging portion 71b engaging with the connector 70, and performs wireless communications with a wireless communication module provided to the external apparatus. The external apparatus is a wireless input operation module such as a wireless keyboard or a wireless mouse. Wireless communication is performed using infrared rays, for example. As illustrated in FIG. 14, at least a part of the wireless communications device 71 (the main body 71a) attached to the connector 70 is located at a position off the display 4 when viewed from the thickness direction of the display 4.

As illustrated in FIG. 16, a container 3y is provided to the corner 3h of the housing 3, specifically, a corner 3z of the first member 3Rr. The container 3y houses the wireless communications device 71 to be attached to the connector 70. The container 3y is formed in a recessed shape and opens toward the backward direction. The container 3y is composed of a bottom 3y1 (a wall or a front wall) and a peripheral wall 3y2 extending in the backward direction from the bottom 3y1. The bottom 3y1 is provided with a plurality of ribs 3y3 (reinforcements). The peripheral wall 3y2 is composed of an upper wall 3y4 (a wall or a wall section), a side wall 3y5 (a first side wall, a wall, or a wall section), a side wall 3y8 (a second side wall, a wall, or a wall section), and a lower wall 3y6 (a wall or a wall section). The upper wall 3y4 is provided with the opening 3v. The side wall 3y5 is provided with an engaging portion 3y7. The container 3y is covered by a cap 75 (refer to FIGS. 3 and 17).

As illustrated in FIG. 17, the cap 75 has a platy base 75a, an engaging portion 75b provided to one edge (an edge or an edge portion) of the base 75a, engaging portions 75c provided to the other edge (the edge or the edge portion) of the base 75a, and a rib 75d provided to the main body 71a. The cap 75 is attached to the first member 3Rr in such a manner that the engaging portions 75c engage with engaging portions (not illustrated) provided to the side wall 3y5 of the container 3y and the engaging portion 75b engages with the engaging portion 3y7 of the container 3y. The cap 75 is removed from the first member 3Rr in such a manner that the engaging portion 75b is removed from the engaging portion 3y7 of the container 3y and the engaging portions 75c are removed from the engaging portions provided to the side wall 3y5.

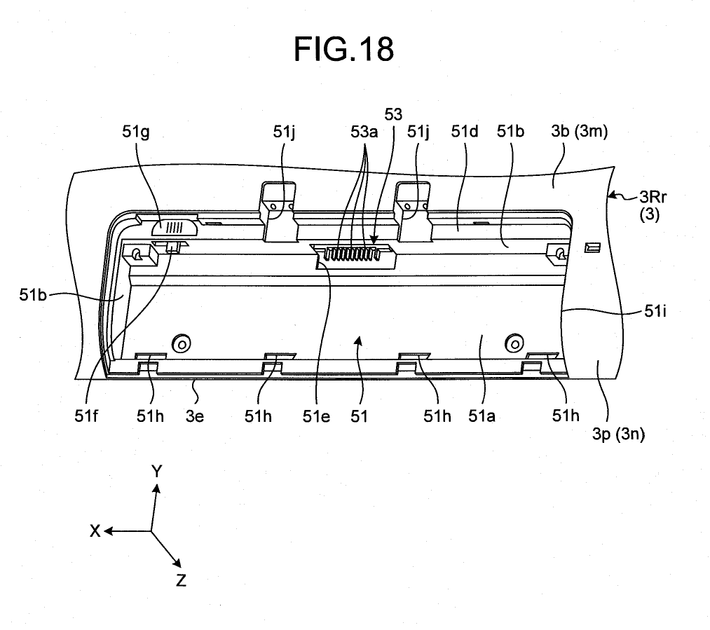

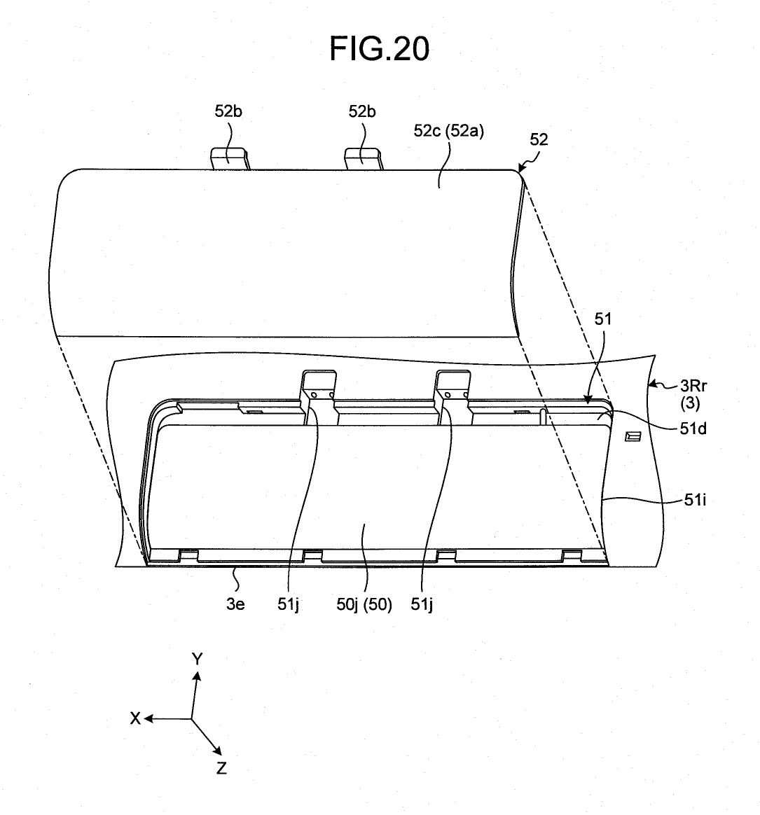

In the embodiment, as exemplarily illustrated in FIGS. 3 and 18, a container 51 for a battery 50 (an electric battery, an electric accumulator, an assembled battery, a battery module, a housed part, a part, a module, or an attachable-detachable part) serving as an apparatus power source is provided to the edge 3e located on the lower side (the support 2Fr side, the support 2Rr side, or the placement surface side) of the housing 3. The container 51 is covered by a cap 52 (a covering portion, a plugging portion, a cover, or a capping portion, refer to FIGS. 3 and 20) while housing the battery 50.

In the embodiment, the container 51 (the battery 50) is provided between the two supports 2Fr, for example. With reference to FIG. 4, it can be seen that the container 51 (the battery 50) is located among three supports 2Fr and 2Rr. In this way, in the embodiment, the container 51 (the battery 50) is provided between the two supports 2Fr and among the three supports 2Fr and 2Rr, for example. As a result, according to the embodiment, the housing 3 is readily prevented from being unbalanced due to provision of the battery 50 having a relatively heavy weight to the housing 3, for example. That is, the gravity center of the television receiver 1 is maintained at a lower position, thereby preventing the television receiver 1 from falling down, for example.

In the embodiment, as exemplarily illustrated in FIG. 3, the support 2Rr is located on a side opposite the screen 4a (the back side, the rear side, or the behind side) of the cap 52, for example. As a result, according to the embodiment, the support 2Rr readily suppresses contact of a user with the cap 52 (operation portions 52b thereof), for example. Consequently, the cap 52 is readily prevented from being opened by mistake, for example.

In the embodiment, as exemplarily illustrated in FIGS. 12 and 13, the battery 50 is located between the two speakers 38 on the lower side of the display 4. As a result, according to the embodiment, a space on the lower side of the display 4 (on the supports 2Fr and 2Rr side) in the housing 3 can be more efficiently used by arranging the speakers 38 and the battery 50 along the edge 3e, for example. In the embodiment, the housing 3 is further readily prevented from being unbalanced by providing the speakers 38 together with the battery 50 to the housing 3, for example. That is, the gravity center of the television receiver 1 is maintained at a lower position, further preventing the television receiver 1 from falling down. In the embodiment, the battery 50 is located at the central position (an intermediate position) of the edge 3e in the long side direction while the two speakers 38 are located so as to interpose the battery 50 therebetween, for example. As a result, according to the embodiment, the television receiver 1 is readily prevented from being unbalanced in the long side direction of the housing 3 (the left-right direction in FIGS. 12 and 13), for example.

In the embodiment, as can be seen from FIGS. 3 and 4, the container 51 (the battery 50) is located apart from the supports 2Fr and 2Rr, for example. As a result, according to the embodiment, the container 51 is readily structured and the stiffness of the supports 2Fr and 2Rr hardly deteriorates compared with a case in which the container 51 and the supports 2Fr and 2Rr are structured so as to be close each other or overlapped, for example.

In the embodiment, as exemplarily illustrated in FIG. 3, the container 51 is provided to the back surface 3b of the housing 3 and opens toward the backward direction, i.e., the side opposite the screen 4a. As a result, according to the embodiment, the container 51 and the cap 52 are hardly seen from the front (the front side) of the screen 4a, for example. Consequently, the container 51 and the cap 52 hardly spoil the appearance of the television receiver 1.

In the embodiment, as exemplarily illustrated in FIG. 18, the container 51 is provided as the recess that extends from the wall 3m to the wall 3n of the first member 3Rr and opens toward the backward direction (the side opposite the screen 4a) and the lower direction (the placement surface side, the side opposite the edge 3c, or the protruding directions of the supports 2Fr and 2Rr). The container 51 extends along the edge 3e. The container 51 is mainly composed of a wall 51a (a bottom wall portion, a bottom wall, or a far side wall) and a wall 51b (a side wall portion, a peripheral wall portion, a side wall, or a peripheral wall). The wall 51a is located on a far side in the recess and provided in such a posture that it is approximately in parallel with the screen 4a or the back surface 3b, i.e., it intersects with a direction orthogonal to the screen 4a (the normal direction) (in the embodiment, e.g., orthogonal to the normal direction), and is along the XY plane. The wall 51a has a rectangular shape. The wall 51b surrounds the wall 51a and intersects with the wall 51a (in the embodiment, e.g., orthogonal to the wall 51a). As described above, the container 51 opens at the edge 3e toward the backward direction and the lower direction in an area from the wall 3m to the wall 3n. Therefore, the wall 51b is not provided in the lower direction. On the wall 51b side, which is away from the edge 3e, of the container 51, a surface 51d (a step surface, a step, a wall, a notch, or a recess) is provided at a position located between the back surface 3b and the wall 51b. In this way, in the embodiment, the container 51 is formed as the recess in the first member 3Rr (the wall 3m and the wall 3n thereof), for example. As a result, the stiffness of the first member 3Rr is more readily increased, for example.

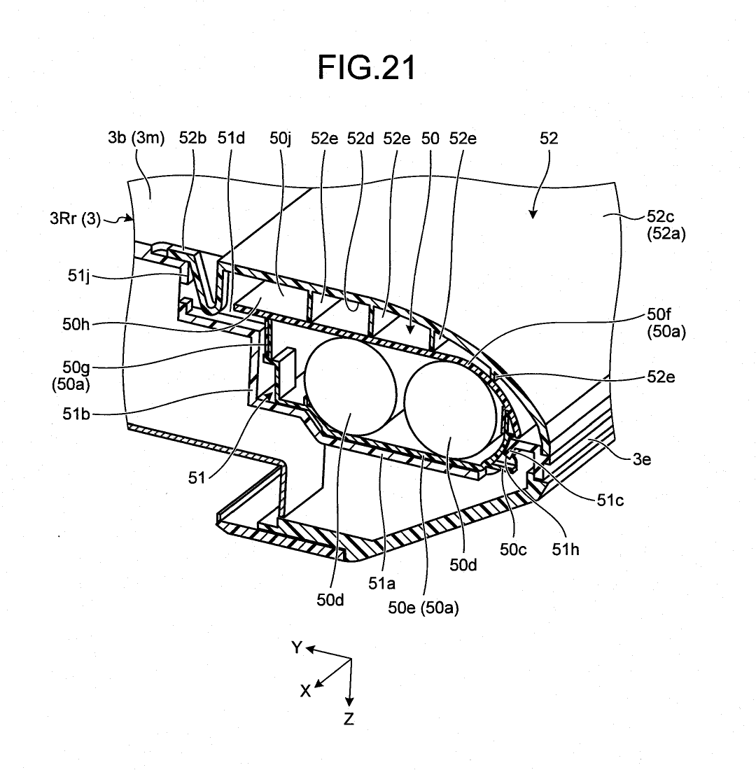

The wall 3m in the container 51 (a border area between the wall 51a and the wall 51b) is provided with an opening 51e, through which a connector portion 53 (a first connector) is exposed. The connector portion 53 has a plurality of fins 53a (walls) provided in parallel with each other. Each of the fins 53a is provided with a terminal (not illustrated) that is electrically connected to a corresponding terminal (not illustrated) of a connector portion 50b (a second connector) of the battery 50 so as to electrically connect conductors in the battery 50 (e.g., electrodes of cells 50d (refer to FIG. 21)) to conductors in the housing 3 (e.g., the circuit board 40 (refer to FIG. 13)). Slits between the fins 53a open at least in the backward and the lower directions.

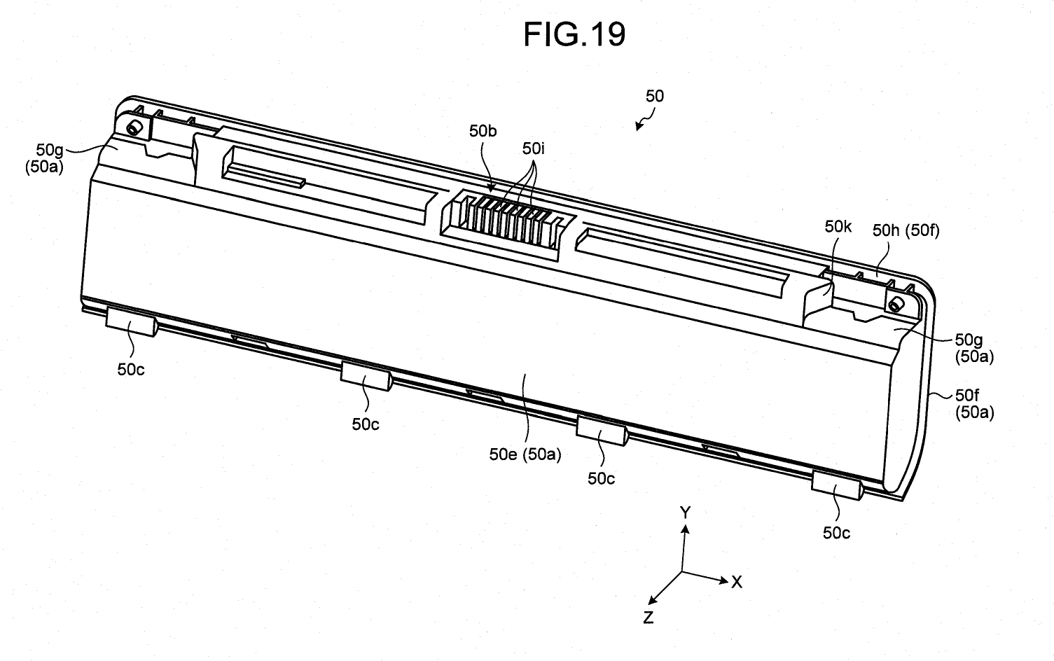

In the container 51, a hook 51f is slidably supported by the wall 51b. The hook 51f (a hooking portion or a pull-out prevention portion) is linked to an operation element 51g (an operation module). A user can switch the state of the battery 50 between being locked to and unlocked from the housing 3 by operating the operation element 51g. The hook 51f and the operation element 51g are urged toward one direction (e.g., the right side in FIG. 18) by an urging member (an elastic member, e.g., a spring, not illustrated). In the container 51, the wall 3m (the wall 51a) on the edge 3e side is provided with openings 51h. The hook 51f is hooked to a hooking portion 50k (refer to FIG. 19) provided to the battery 50, thereby suppressing coming off of the battery 50 from the container 51.

In the embodiment, as exemplarily illustrated in FIG. 19, the battery 50 has a flat and elongated shape. The battery 50 comprises a housing 50a, the connector portion 50b, protrusions 50c, and the cells 50d (refer to FIG. 21). As illustrated in FIG. 21, the housing 50a comprises an inner wall 50e (a wall), an external wall 50f (a wall), and an upper wall 50g (a wall). One edge of the external wall 50f in the width direction thereof (the edge on the upper side in FIG. 19) extends outside and is provided with a flange 50h. The connector portion 50b is provided between the upper wall 50g and the flange 50h. The connector portion 50b has a plurality of fins 50i (walls) provided in parallel with each other. Each of the fins 50i is provided with a terminal (not illustrated) that is electrically connected to a corresponding terminal (not illustrated) of the connector portion 53 provided to the housing 3 so as to electrically connect the conductors in the battery 50 (e.g., the electrodes of the cells 50d) to the conductors in the housing 3 (e.g., the circuit board 40 (refer to FIG. 13)). Slits between the fins 53a open toward at least in the forward direction (the screen 4a side) and the upper direction (a side opposite the placement surface, or the opposite direction of the protruding directions of the supports 2Fr and 2Rr) when the battery 50 is attached.

In the embodiment, as exemplarily illustrated in FIGS. 20 and 21, the cap 52 (covering portion) covers the battery 50 and the container 51 while the battery 50 is housed in the container 51. The cap 52 comprises a wall 52a, the operation portions 52b, and ribs 52e (protrusions). The wall 52a covers (plugs) an opening edge 51i of the container 51 and forms a surface continuing to the walls 3m and 3n. That is, when the cap 52 is placed, an external surface 52c (a surface or a surface portion) of the wall 52a forms a smooth curved surface continuing to the back surface 3b of the wall 3m and the extending surface 3p of the wall 3n. The operation portions 52b are inserted into openings 51j provided to the wall 3m by being elastically deformed and hooked by the rims of the openings 51j. A user can take out the cap 52 by elastically deforming the operation portions 52b and releasing the engagement with the rims of the openings 51j.

In the embodiment, as exemplarily illustrated in FIG. 21, an inner surface 52d (a surface or a surface portion) on the battery 50 side of the wall 52a is provided with the ribs 52e (protrusions or walls) protruding toward the battery 50. Providing the ribs 52e to the inner surface 52d readily increases the stiffness of the cap 52. With reference to FIG. 21, it can be seen that a clearance is provided between an external surface 50j of the battery 50 and the inner surface 52d of the wall 52a of the cap 52 in such a manner that the distance therebetween changes. That is, according to the embodiment, the use of the cap 52 eliminates the necessity to thoroughly match the shape of the external wall 50f of the battery 50 to those of the walls 3m and 3n of the housing 3, for example. As a result, the use of the cap 52 readily increases flexibility in design of the battery 50, for example.

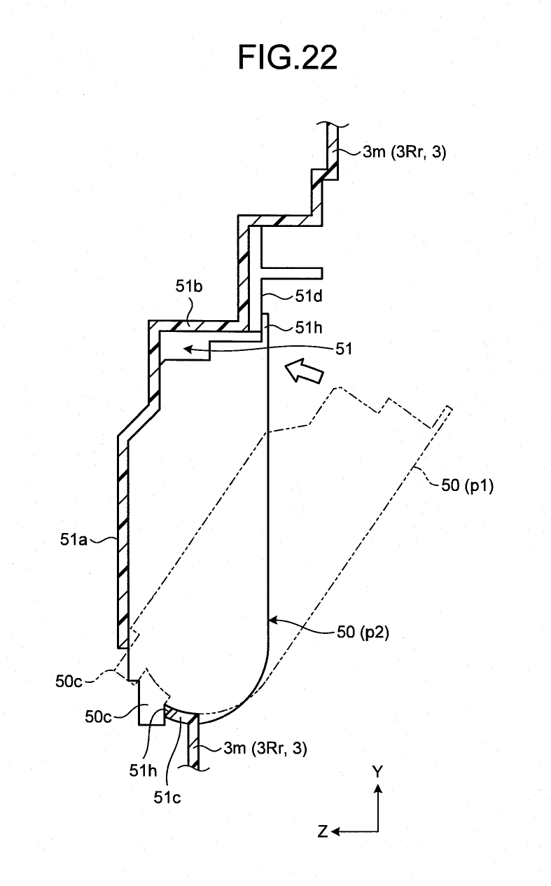

In the embodiment, as exemplarily illustrated in FIG. 22, when the battery 50 is housed in the container 51, the protrusions 50c of the battery 50 are inserted into the openings 51h. Then, the battery 50 is rotated from a first position P1 to a second position P2 while the protrusions 50c (fourth supports) of the battery 50 are supported by rims 51c (third supports) of the openings 51h. As a result, the battery 50 is housed in the container 51. According to the embodiment, the battery 50 thus can be relatively simply housed in the container 51, for example. The connector portion 50b is provided with the fins 50i and the slits while the connector portion 53 is provided with the fins 53a and the slits. The slits are provided at least along a circumferential direction of the rotation of the battery 50. In the embodiment, the slits are provided along the YX plane, for example. The connector portion 50b is rotatable between the first position P1 at which the connector portion 50b is apart from the connector portion 53 and the second position P2 at which the connector portion 50b is electrically connected to the connector portion 53.

As described above, in the embodiment, the television receiver 1 comprises the two first supports 2Fr, which have the protrusions 21e protruded from the positions on the edge 3e on the short side direction side of the second member 3Md and closer to the central area than the edges 3d and 3f located both sides in the long side direction of the screen 4a, and the second support 2Rr protruded from the first member 3Rr so as to be apart from the two first supports 2Fr, for example. As a result, according to the embodiment, the television receiver 1 can be supported by a narrower region, e.g., by the first supports 2Fr and the second support 2Rr. Accordingly, the television receiver 1 is readily placed in a narrower space, for example. Furthermore, a portion including the first supports 2Fr looks slimmer or smaller than a structure having the supports on both sides in the long side direction, for example.

In the embodiment, the television receiver 1 comprises the battery 50 and the cap 52 covering the container 51, for example. The battery 50 is located at the position on the edge 3e located on the first support 2Fr side of the first member 3Rr and between the two first supports 2Fr, and detachably housed in the container 51 that opens toward the side opposite the screen 4a. As a result, according to the embodiment, the external wall 50f and the external surface 50j of the battery 50 do not need to be fitted in the back surface 3b and the extending surface 3p of the housing 3, for example. Accordingly, flexibility in design of the battery 50 is readily increased, for example. Consequently, manufacturing time and costs of the battery 50 are readily further reduced, for example.

In the embodiment, the container 51 is provided to the first member 3Rr as the recess, for example. As a result, according to the embodiment, the walls 3m and 3n are bent at the portion in which the container 51 is provided, thereby readily increasing the stiffness of the walls 3m and 3n, and furthermore, the housing 3, for example.

In the embodiment, the container 51 (the battery 50) is provided between the two supports 2Fr and among the three supports 2Fr and 2Rr, for example. As a result, according to the embodiment, the housing 3 is readily prevented from being unbalanced due to provision of the battery 50 having a relatively heavyweight to the housing 3, for example. That is, the structure further prevents the television receiver 1 from falling down, for example.

While the embodiment has been described, the embodiment has been presented by way of examples only, and is not intended to limit the scope of the invention. The embodiment described above may be embodied in a variety of other forms. Furthermore, various omissions, substitutions and changes of the embodiment described herein may be made without departing from the spirit of the invention. The accompanying claims and their equivalents are intended to cover the embodiment or modifications as would fall within the scope and spirit of the invention. The technical features of the embodiment and the modified examples can be carried out in any combination of them or by partially replacing them with each other. The specifications (e.g., the structure, the type, the set direction, the shape, the size, the length, the width, the thickness, the height, the number of elements, the arrangement, the position, or the material) of each structure and portion can be changed as appropriate.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A television receiver comprising:
a display comprising a screen;
a cover configured to cover at least a side of the display, the side opposite the screen;
a mask configured to cover a periphery of the screen from a side opposite the cover;
a middle frame between the mask and the cover, the middle frame configured to cover at least a peripheral edge of the display;
two first supports configured to be provided integrally with the middle frame, each of the first supports comprising a protrusion protruding from a position on an edge of the middle frame on a short side direction side of the screen and closer to a central area than a corresponding edge of the middle frame in a long side direction of the screen;
a second support configured to protrude from the cover so as to be separated from the two first supports;
a battery configured to be housed in a detachable manner in a container between the two first supports and on an edge on a side of the two first supports of the cover, the container opening toward a side opposite the screen; and
a covering portion configured to cover the container.

2. The television receiver of claim 1, wherein the container is a recess provided in the cover.

3. The television receiver of claim 2, wherein the covering portion comprises a surface facing the battery and a second protrusion protruding toward the battery from the surface.

4. The television receiver of claim 2, wherein the second support is located on a side of the covering portion, the side opposite the screen.

5. The television receiver of claim 2, further comprising two speakers configured to be located at positions between the middle frame and the cover and on the side of the two first supports of the display so as to interpose the battery.

6. The television receiver of claim 1, wherein the battery comprises a fourth support supported by a third support provided in the cover and is housed in the container, the battery configured to rotate around the fourth support.

7. The television receiver of claim 6, wherein
the battery comprises a second connector electrically connected to a first connector in the cover, and
the second connector is rotatable around the fourth support serving as a supporting point from a first position at which the second connector is separated from the first connector to a second position at which the second connector is electrically connected to the first connector.

8. An electronic apparatus comprising:
a display comprising a screen;
a first member configured to cover at least a side of the display, the side opposite the screen;
a second member configured to be located closer to the screen than the first member and to cover at least a periphery of the display;
a third member configured to be located on a periphery of the screen, the third member comprising a wall along the screen;
a support comprising a protrusion protruding from an edge of the second member on a short side direction side of the screen;
a container configured to open on a side opposite the screen at a position on the edge of the third member on the short side direction side of the screen and separated from the support, and to extend along the edge;
a battery configured to be housed in a detachable manner in the container; and
a cover configured to cover the container.

9. An electronic apparatus comprising:
a display comprising a screen;
a housing configured to house at least a part of the display when the screen is exposed;
three supports configured to protrude from the housing and to support the housing;
a container configured to be provided on a side of the housing and located among the three supports, the side opposite the screen; and
a housed part configured to be housed in a detachable manner in the container.
